(19) United States
(12) Patent Application Publication
(10) Pub. No.: US 2018/0173624 A1
(43) Pub. Date: Jun. 21, 2018

(54) METHOD AND APPARATUS FOR DATA ACCESS IN STORAGE SYSTEM

(71) Applicant: EMC IP Holding Company LLC, Hopkinton, MA (US)

(72) Inventors: Shuo LV, Beijing (CN); Deric Wenjun Wang, Beijing (CN); Qingyun Liu, Beijing (CN); Mingxin Li, Beijing (CN)

(21) Appl. No.: 15/846,828

(22) Filed: Dec. 19, 2017

(30) Foreign Application Priority Data
Dec. 21, 2016 (CN) CN201611192895.9

(51) Int. Cl. G06F 12/084; G06F 12/0875; G06F 12/0893

(52) U.S. Cl. CPC G06F 12/084; G06F 12/0875; G06F 2212/62; G06F 2212/60; G06F 12/0893

(57) ABSTRACT

Embodiments of the present disclosure provide a method and apparatus for data access in a storage system. The solution divides local cache of each of the plurality of controllers in the storage system into dedicated area and shared area, wherein the shared area is uniformly addressed to form a global shared address space. Accordingly, a controller can access and utilize local cache that originally belongs to other controllers, so as to improve cache utilization rate of the storage system. The plurality of controllers in the storage system has a high-speed communication interface therebetween. The solution of the present disclosure enables a controller to utilize cache resources of other controllers in the storage system, so as to achieve the purpose of coordinating cache resources in the storage system.

### RELATED APPLICATIONS

This application claim priority from Chinese Patent Application Number CN201611192895.9, filed on Dec. 21, 2016 at the State Intellectual Property Office, China, titled “METHOD AND APPARATUS FOR DATA ACCESS IN STORAGE SYSTEM” the contents of which is herein incorporated by reference in its entirety.

### FIELD

Embodiments of the present disclosure generally relate to the field of storage systems, and more specifically, to a method and apparatus for data access in a storage system.

### BACKGROUND

At present, many kinds of data storage systems based on redundant disk arrays have been developed to improve data reliability. When one or more disks in a storage system fail, data in the failed disk can be recovered from data on a disk operating normally. The storage system can be accessed by a storage control node. Each storage control node has its own memory. The memory can be cache. However, it currently lacks a unified scheduling mechanism to coordinate storage and data access behaviors of each storage control node in the system. The mismatch between a plurality of control nodes may degrade the overall performance of the storage system.

### SUMMARY

Embodiments of the present disclosure provide a method and apparatus for data access in a storage system, a storage system, and a computer program product.

According to the first aspect of the present disclosure, there is provided a method for data access in a storage system. The method comprises: receiving, from a controller among a plurality of controllers in the storage system, an access request for data, the plurality of controllers having their respective local caches; determining whether the data is located in a dedicated area of the local cache of the controller; in response to the data being missed in the dedicated area of the local cache of the controller, determining an address of the data in a global address space, the global address space corresponding to respective shared areas in the local cache of the plurality of controllers; and searching the data using the address in the global address space.

According to the second aspect of the present disclosure, there is provided an apparatus for data access in a storage system. The apparatus comprises: an access request receiving unit, a dedicated area determining unit, a global address determining unit, and a data searching unit. The access request receiving unit is configured to receive an access request for data from a controller among a plurality of controllers in the storage system, the plurality of controllers having their respective local caches. The dedicated area determining unit is configured to determine whether the data is located in a dedicated area of the local cache of the controller. The global address determining unit is configured to, in response to the data being missed in the dedicated area of the local cache of the controller, determine an address of the data in a global address space, the global address space corresponding to respective shared areas in the local cache of the plurality of controllers. The data searching unit is configured to search the data using the address in the global address space.

According to the third aspect of the present disclosure, there is provided a storage system including a plurality of controllers. The plurality of controllers have their respective local caches. At least some of the plurality of controllers are configured to perform the method according to the first aspect of the present disclosure.

According to the fourth aspect of the present disclosure, there is provided a computer program product being tangibly stored on a non-transitory computer readable medium and comprising machine executable instructions which, when executed, cause the machine to perform the method according to the first aspect of the present disclosure.

The summary is provided to introduce the selections of concepts in s simplified way, which will be further explained in the following detailed descriptions of the embodiments. The summary bears no intention of identifying key or vital features of the present disclosure or limiting the scope of the present disclosure.

### BRIEF DESCRIPTION OF THE DRAWINGS

Through the more detailed description of example embodiments of the present disclosure with reference to accompanying drawings, the above and other objectives, features, and advantages of the present disclosure will become more apparent, wherein same reference signs in example embodiments of the present disclosure usually represent the same components.

FIG. 1 is a block diagram illustrating a storage system according to an embodiment of the present disclosure;

FIG. 2 is a flow chart illustrating a data access method in the storage system according to an embodiment of the present disclosure;

FIG. 3 is a schematic diagram illustrating a data access apparatus in the storage system according to an embodiment of the present disclosure;

FIG. 4 is a schematic block diagram illustrating an exemplary device capable of implementing embodiments of the present disclosure.

### DETAILED DESCRIPTION OF EMBODIMENTS

Preferred embodiments of the present disclosure will be described in more details with reference to the drawings. Although the drawings demonstrate the preferred embodiments of the present disclosure, it should be appreciated that the present disclosure can be implemented in various manners and should not be limited to the embodiments explained herein. On the contrary, these embodiments are provided to make the present disclosure more thorough and complete and to fully convey the scope of the present disclosure to those skilled in the art.

As used herein, the term “includes” and its variants are to be read as open-ended terms that mean “includes, but not limited to.” The term “or” is to be read as “and/or” unless the context clearly indicates otherwise. The term “based on” is to be read as “based at least in part on.” The terms “one example embodiment” and “one embodiment” are to be read as “at least one example embodiment.” The term “a further embodiment” is to be read as “at least a further embodiment.” The terms “first”, “second” and so on can refer to same of different objects. The following text can comprise other explicit and implicit definitions.

As described above, a storage system can be accessed via a storage control node. Each storage control node comprises its own memory, wherein the memory can be cache. In some storage systems, each storage control node can only utilize its own memory. Therefore, it lacks a unified scheduling mechanism to coordinate memory resources of each storage control node in the system. Data communication between two storage control nodes will occupy a large amount of time, which causes the external host to wait long time for data read and write. Thus, it is important about how to effectively utilize and schedule memory resources among different storage control nodes to improve performance of a storage system.

The storage system of the present disclosure can be redundant array of independent disks (RAID). RAID can combine a plurality of storage devices to form a disk array. Providing redundant storage devices can enable the entire disk group to be much more reliable than a single storage device. Compared with a single storage device, RAID can provide various advantages, such as enhancing data integration, improving fault tolerance, and increasing throughput or capacity. with the development of storage device, RAID experiences many standards, e.g., RAID-1, RAID-10, RAID-3, RAID-30, RAID-5, and RAID-50. An operating system can regard the disk array formed of a plurality of storage devices as a single logic storage unit or disk. By dividing the disk array into a plurality of strips, data can be distributed onto a plurality of storage devices, so as to achieve low latency and high bandwidth, and data can be recovered to some extent after a part of the disks have been damaged. A storage control node can comprise a control component and a storage component. The storage component, for example, can be cache. When the storage control node receives an access request (e.g., read and write request) from an external host, the control component processes the request and looks up data associated with the request in the storage component to determine whether the data has been loaded in the storage component. If the associated data has been loaded (hit), the control node can continue to perform the access request; if the associated data does not exist in the storage component (miss), it requires allocating corresponding available storage space in the storage component to perform the request. The control component and the storage component can be separated with each other or integrated as a whole. The storage component can also be included in the control component.

To at least partially solve the above problem and other potential problems, example embodiments of the present disclosure provide a solution for data access in a storage system. The solution divides local cache of each of the plurality of controllers in the storage system into dedicated area and shared area, wherein the shared area is uniformly addressed, so as to form a global shared address space. The plurality of controllers in the storage system has internal high-speed communication interfaces therebetween. The solution of the present disclosure enables one controller to use cache of other controllers in the storage system, so as to achieve the purpose of coordinating cache resources in the storage system.

It should be understood that embodiments of the present disclosure are not limited to RAID. The spirit and principle suggested here are also applicable to any other storage systems having a plurality of controllers, whether being currently known or to be developed in the future. The following text takes RAID as an example to describe embodiments of the present disclosure to merely help understand the solution of the present disclosure without any intentions of limiting the scope of the present disclosure in any manner.

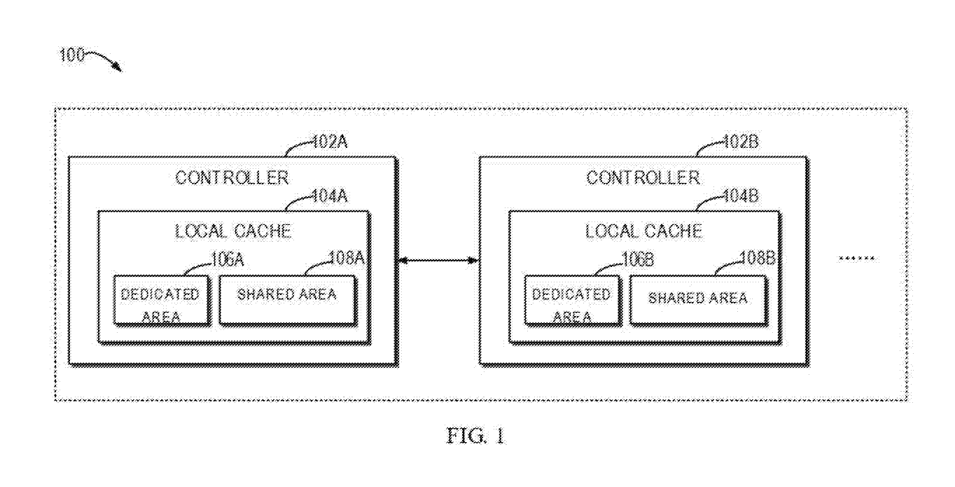

FIG. 1 illustrates a block diagram of a storage system 100 according to embodiments of the present disclosure. It should be understood that structures and functions of the storage system 100 are described only for exemplary purpose rather than suggesting any limitations on the scope of the present disclosure. That is, some components in the system 100 can be omitted or replaced, while other components not shown can be added in the system 100. Embodiments of the present disclosure can be embodied in different structures and/or functions. For example, the large-scale storage disk array included in the storage system 100 is not shown in FIG. 1.

As shown in FIG. 1, the storage system 100 comprises a controller 102A and a controller 102B. It should be understood that although FIG. 1 illustratively shows two controllers, the storage system can comprise more than two controllers. The controller 102A has a local cache 104A and the controller 102B has a local cache 104B. As a non-restrictive implementation, the local cache 104A and the local cache 104B can be dynamic random access memory (DRAM) or static random access memory (SRAM).

It should be understood that the controller 102A can share local cache with other controllers in the storage system 100. In other words, multiple controllers can share one local cache module. Likewise, the controller 102A can also comprise a plurality of combined local cache, i.e., the local cache 104A can be consisted of a plurality of combined cache modules. Besides, the local cache 104A can belong to the controller 102A or be coupled to the controller 102A through a communication interface.

According to embodiments of the present disclosure, the local cache 104A is divided into a dedicated area 106A and a shared area 108A. The local cache 104B comprises an dedicated area 106B and a shared area 108B. The dedicated area 106A is dedicatedly used by the controller 102A. The dedicated area 106B is dedicatedly used by the controller 102B. The shared areas 108A and 108B can be shared by a plurality of controllers in the storage system 100. That is, the shared areas 108A and 108B form a storage space shared by the controllers 102A and 102B.

It should be understood that the local cache 102A can also comprise other cache portions, such as a cache portion storing core codes, apart from the dedicated area 106A and shared area 108A. The core codes can be codes required to run the operating system of the controller 102A. For the sake of conciseness, FIG. 1 does not show the cache portion storing core codes of the controller 102A.

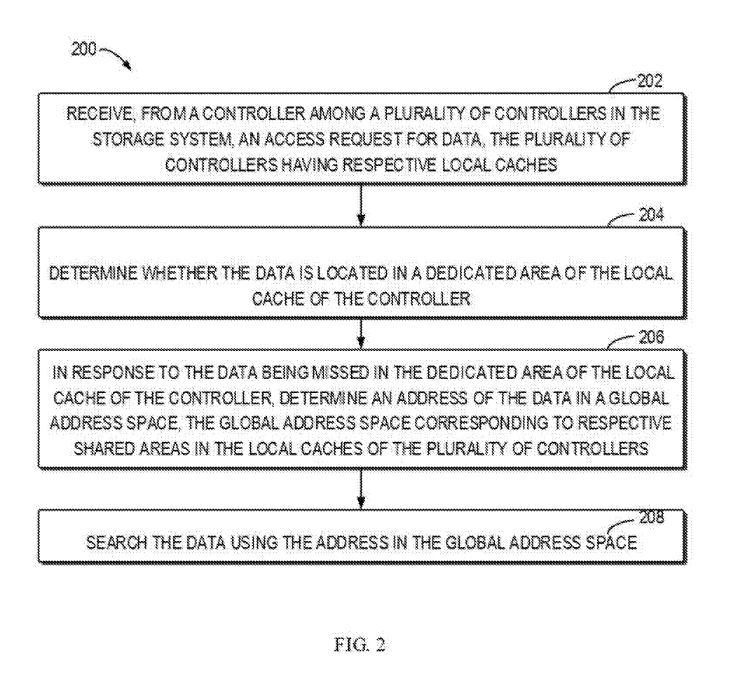

Example embodiments of the present disclosure will be further explained with reference to FIGS. 2 to 4. To facilitate description, the controller 102A acts as the example to discuss several example embodiments of the present disclosure. However, it will be understood that the features described below are also applicable to other one or more controllers, such as the controller 102B.

FIG. 2 illustrates a flow chart of a data access method 200 for use in the storage system 100 according to embodiments of the present disclosure. It should be understood that the method 200 can also comprise additional steps not shown and/or shown steps that can be omitted. The scope of the present disclosure is not restricted in this regard.

At 202, an access request for data is received from the controller 102A of the storage system 100. As described above, the controller 102A comprises a local cache 104A and the controller 102B comprises a local cache 104B. In some embodiments, the access request for data by the controller 102A can be caused by data input and output request of an external client. In some embodiments, the access request for data by the controller 102A can be caused by input and output request for program codes.

At 204, whether the data is located in the dedicated area 106A of the local cache 104A of the controller 102A is determined. In some embodiments, the dedicated area 106A stores data often used by the controller 102A. Based on the load condition of the controller 102A, the proportion of the dedicated area 106A in the local cache 104A can be preconfigured. For example, when the controller 102A is heavily loaded and demands more of cache resources, the dedicated area 106A can occupy a large portion of the local cache 104A. As a non-restrictive implementation, data in the dedicated area 106A can be erased if it is not used until a time period threshold has exceeded.

At 206, if the requested data is missed in the dedicated area 106A of the local cache 104A of the controller 102A, the address of the data in the global address space is determined. The global address space is a space formed by the shared areas 108A and 108B in the local cache 104A and 104B of each controller 102A and 102B. Global addresses are created in the storage space. That is, each controller 102A and 102B can search particular data in the global address space using the global address.

As a non-restrictive implementation, a mapping table between an address of the shared area 106A in the local cache 104A of the controller 102A and the global address. In some embodiments, the mapping table has a plurality of layers. For example, the first layer corresponds to the serial number of the controller, the second layer corresponds to a specific page of a specific controller, and the third layer corresponds to a certain line of the specific page. By dividing a portion of the local cache 104A into the shared area 106A, a plurality of controllers in the storage system 100 are enabled to utilize the shared area 106A, so as to implement cache sharing and coordination between different controllers.

As a non-restrictive implementation, before creating the global address space, a global shared storage environment and parameters required by system operations need to be configured. For example, sizes of the dedicated areas 106A and 106B, sizes of the shared areas 108A and 108B, the data structure required by system operation, handling mode of the page fault interruption, communication mode, and communication links between different controllers need to be configured. It should be understood that creating and allocating operations of the global address space can be completed by cooperation of each controller in the storage system 100. For example, an application specialized in handling the global address space can be installed in each controller and each application communicates and coordinates with one another. It can be understood that the controller 102A can serve as the main controller for loading the application specialized in handling the global address space, wherein the applications collect cache information of each controller, so as to uniformly manage cache.

As a non-restrictive implementation, a fixed size of area can be divided from the local cache of each controller to act as the shared area. In some embodiments, a cyclic method is utilized to make the division of the local cache of each controller to be more uniform. That is, an initial size of local cache is first divided for each controller in the storage system, and then the next round of dividing operation is performed based on the load condition of each controller. As a non-restrictive implementation, the ratio between the shared area 108A and the local cache 104A can be different from that between the shared area 108B and the local cache 104B. It should be understood that when a new controller is added to the storage system 100, a part of the local cache of the new controller can also be divided into the shared area.

As a non-restrictive implementation, the division for the local cache of each controller can be preconfigured, or be dynamically adjusted. In some embodiments, for example, if the size of the dedicated area 106A of the local cache 104A in the controller 102A is insufficient to support cache read and write operations of the controller 102A, at least a part of the shared area 108A can be converted to the dedicated area 106A. It will be appreciated that at least a part of the shared area 108B can also be converted to the dedicated area 106A.

At 208, data is searched using the address in the global address space. As a non-restrictive implementation, the data can be searched by means of address comparison method. For instance, several bits at the beginning of the global address can correspond to the serial number of the controller, and then the comparison operation can be performed first on the several bits at the beginning of the search procedure.

In some embodiments, searching data using the address in the global address space also comprises determining whether the data is located in the shared area 108A of the local cache 104A of the controller 102A or not. In some embodiments, data is determined to be within the shared area 106A by a method of matching the mapping table. It can be appreciated that matching the mapping table can be performed using all kinds of implementation manners.

In some embodiments, if the data is located in the shared area 108A of the local cache 104A in the controller 102A, the data is accessed in the shared area 108A of the local cache 104A in the controller 102A. The data is subsequently transmitted to the dedicated area 106A of the local cache 104A in the controller 102A. As a non-restrictive implementation, the cache entry of the controller 102A is updated, such that the controller 102A can access the data directly.

In some embodiments, if the data is missed in the shared area 108A of the local cache 104A of the controller 102A, the local cache 104B of the controller 102B storing the data is determined by the address. After the determination, the data is obtained from the local cache 104B of the controller 102B. Then the data is transmitted to the dedicated area of the local cache in the controller. As a non-restrictive implementation, if the data is missed in the shared area 108A of the local cache 104A of the controller 102A, the storage system 100 can perform a page fault interrupt handling. After determining the local cache 104B of the controller 102B storing the data to be accessed, the data to be accessed is transmitted via an internal high-speed communication interface between the controller 102A and the controller 102B. It should be understood that the controller 102A may not know that the data to be accessed is located in the local cache 104B of the controller 102B. In other words, the controller 102A is only aware that the data to be accessed is obtained from the global shared area.

In some embodiments, the controller 102A and the controller 102B communicate with each other by means of the internal high-speed interface. As a non-restrictive implementation, an internal communication network is established among a plurality of memory in the storage system 100.

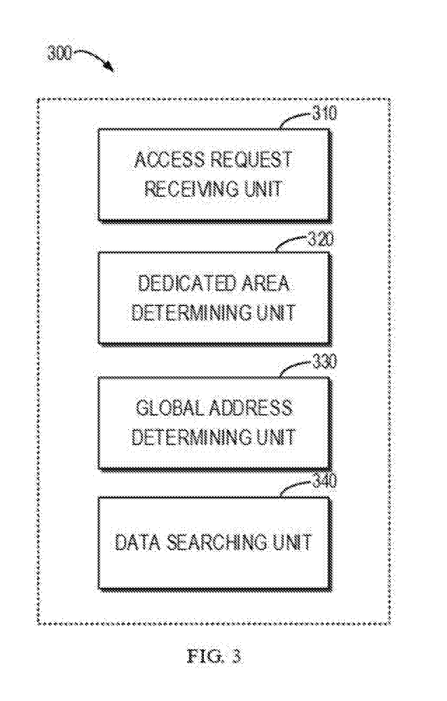

FIG. 3 illustrates a schematic diagram of apparatus 300 for data accessing in a storage system according to embodiments of the present disclosure. In some embodiments, for example, the apparatus 300 can be implemented on the controller 102A. It can be understood that the block diagram is listed merely to make the present disclosure more comprehensible and is not intended for limiting the implementations of the present disclosure. The apparatus 300 can comprise additional modules not shown and/or shown modules that can be omitted.

The apparatus 300 comprises an access request receiving unit 310, a dedicated area determining unit 320, a global address determining unit 330, and a data searching unit 340. The access request receiving unit 310 is configured to receive an access request for data from one of a plurality of controllers in the storage system, wherein each of the plurality of controllers has its own local cache. The dedicated area determining unit 320 is configured to determine whether the data is located in the dedicated area of the local cache of the controller. The global address determining unit 330 is configured to determine the address of the data in the global address space in response to the data being missed in the dedicated area of the local cache of the controller, the global address space corresponding to respective shared area in the local cache of the plurality of controllers. The data searching unit 340 is configured to search the data using the address in the global address space.

In some embodiments, the data searching unit 340 is further configured to determine whether data is located in the shared area of the local cache of the controller.

In some embodiments, the data searching unit 340 is further configured to: in response to the data being located in the shared area of the local cache of the controller, access data in the shared area of the local cache of the controller; transmit the data to the dedicated area of the local cache of the controller.

In some embodiments, the data searching unit 340 is further configured to: in response to the data being missed in the shared area of the local cache of the controller, determine the local cache of another controller for data storage using the address; obtain the data from the local cache of the another controller; transmit the data to the dedicated area of the local cache of the controller.

In some embodiments, as described above with reference to FIG. 2, the plurality of controllers communicates with each other via internal high-speed interfaces.

For the purpose of clarity, FIG. 3 does not show some optional modules of the apparatus 300. However, it should be understood that each feature described above with reference to FIGS. 1 and 2 is also applicable to the apparatus 300. Besides, each module of the apparatus 300 can be a hardware module or a software module. For example, in some embodiments, the apparatus 300 can be partially or fully implemented by software and/or firmware, e.g., being implemented as computer program products included in a computer readable medium. Alternatively or additionally, the apparatus 300 can be partially or fully implemented based on the hardware, e.g., being implemented as an integrated circuit (IC), an application-specific integrated circuit (ASIC), a system-on-chip (SOC), a field programmable gate array (FPGA) etc. The scope of the present disclosure is not limited in this regard.

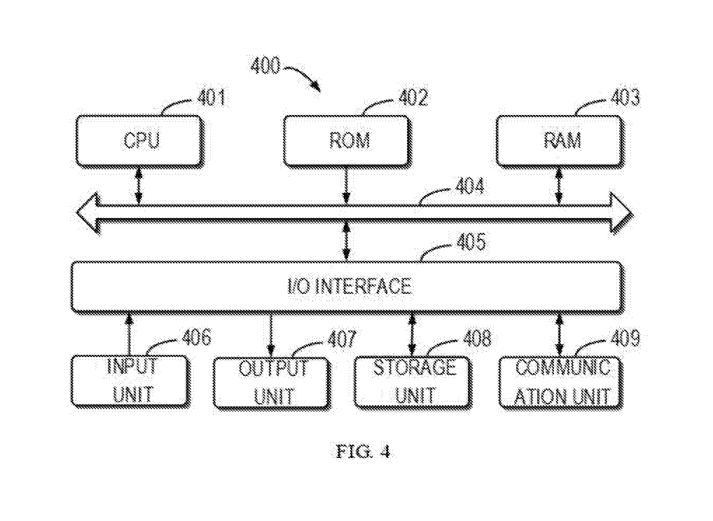

FIG. 4 illustrates a schematic block diagram of a device 400 for implementing embodiments of the present disclosure. As shown, the device 400 comprises a central processing unit (CPU) 401, which can execute various suitable actions and processing based on computer program instructions stored in the read-only memory (ROM) 402 or loaded into the random-access memory (RAM) 403 from the storage unit 408. The RAM 403 can also store all kinds of programs and data required by the device 400 for operation. CPU 401, ROM 402, and RAM 403 are connected to each other via a bus 404. The input/output (I/O) interface 405 is also connected to the bus 404.

Multiple components in the device 400 are connected to the I/O interface 405, including: an input unit 406, such as a keyboard, a mouse, and the like; an output unit 407, such as various displays and loudspeakers; a storage unit 408, such as disks, optical disks, and so on; and a communication unit 409, such as a network card, a modem, a radio communication transceiver. The communication unit 409 allows the device 400 to exchange information/data with other devices via computer networks, such as Internet and/or various telecommunication networks.

Each procedure and processing as described above, e.g., the method 200 or 300, can be executed by the processing unit 401. For example, in some embodiments, the method 200 or 300 can be implemented as computer software program tangibly included in a machine-readable medium, e.g., the storage unit 408. In some embodiments, the computer program is partially or fully loaded and/or installed to the device 400 via ROM 402 and/or communication unit 409. When the computer program is loaded to the RAM 403 and executed by the CPU 401, one or more steps of the above described method 200 or 300 can be performed. Alternatively, in other embodiments, CPU 401 can also be configured in any other suitable manners to implement the above procedure/method.

The present disclosure describes a method for providing global shared area in a multi-controller disk array system. In the multi-controller storage system, the cache of the multiple controllers is uniformly addressed. In this way, each controller can directly access the resources of the entire virtual shared area. Because the cache is uniformly addressed, no messages need to be transferred between different controllers, thereby reducing system overheads across controllers. The method of the present disclosure can improve storage efficiency of the multi-controller storage system.

The present disclosure can be a method, a device, a system, and/or a computer program product. The computer program product can comprise computer-readable storage medium loaded with computer-readable program instructions thereon for executing various aspects of the present disclosure.

The computer-readable storage medium can be a tangible device capable of maintaining and storing instructions used by the instruction-executing devices. The computer readable storage medium may include, but is not limited to, for example a electrical storage device, a magnetic storage device, an optical storage device, an electromagnetic storage device, a semiconductor storage device, or any suitable combination of the foregoing. More specific examples (non-exhaustive list) of the computer-readable storage medium includes the following: a portable storage disk, a hard disk, a random-access memory (RAM), a read-only memory (ROM), an erasable programmable read-only memory (EPROM or flash), a flash memory SSD, PCM SSD, 3D cross memory (3DXPoint), a static random-access memory (SRAM), a portable compact disk read-only memory (CD-ROM), digital versatile disk (DVD), a memory stick, a floppy disk, a mechanically encoded device, such as punched cards or embossment within a groove stored with instructions thereon, and any suitable combinations of the foregoing. A computer-readable storage medium, as used herein, is not interpreted as transient signal per se, e.g., radio waves or freely propagated electromagnetic waves, electromagnetic waves propagated via waveguide or other transmission medium (e.g., optical pulse through a optic fiber cable), or electric signals transmitted through a wire.

Computer-readable program instructions described herein can be downloaded to respective computing/processing device from a computer readable storage medium, or to an external computer or external storage device via networks, for example, the Internet, a local area network, a wide area network and/or a wireless network. The network may comprise copper transmission cables, optical fiber transmission fibers, wireless transmission, routers, firewalls, switches, gateway computers and/or edge servers. A network adapter card or network interface in each computing/processing device receives computer readable program instructions from the network and forwards the computer readable program instructions for storage in the computer-readable storage medium within the respective computing/processing device.

Computer program instructions for carrying out operations of the present disclosure may be assembly instructions, instructions of instruction set architecture (ISA), machine instructions, machine dependent instructions, microcode, firmware instructions, state setting data, or either source code or object code written in any combinations of one or more programming languages, wherein the programming languages, including object-oriented programming languages, such as Smalltalk, C++ or the like, and conventional procedural programming languages, such as the “C” language or similar programming languages. The computer readable program instructions may execute entirely on the user's computer, partly on the user's computer, as a stand-alone software package, partially on the user computer and partially on the remote computer, or completely on the remote computer or server. In the case where remote computer is involved, the remote computer can be connected to the user computer via any type of networks, including a local area network (LAN) and a wide area network (WAN), or to the external computer (for example, through the Internet using an Internet Service Provider). In some embodiments, state information of the computer-readable program instructions is used to customize an electronic circuit, for example, programmable logic circuits, field programmable gate arrays (FPGA) or programmable logic arrays (PLA). The electronic circuit can execute computer-readable program instructions to implement various aspects of the present disclosure.

Various aspects of the present disclosure are described herein with reference to flow charts and/or block diagrams of method, apparatuses (systems) and computer program products according to embodiments of the present disclosure. It should be understood that each block of the flow charts and/or block diagrams and the combination of each block in the flow chart and/or block diagram can be implemented by computer-readable program instructions.

These computer-readable program instructions may be provided to the processing unit of a general-purpose computer, a dedicated computer or other programmable data processing apparatuses to produce a machine, such that the instructions that, when executed by the processing unit of the computer or other programmable data processing apparatuses, generate an apparatus for implementing functions/actions stipulated in one or more blocks in the flow chart and/or block diagram. These computer-readable program instructions may also be stored in the a computer readable storage medium and that can direct a computer, a programmable data processing apparatus, and/or other devices to function in a particular manner, such that the computer readable medium stored with instructions comprises an article of manufacture including instructions for implementing various aspects of the functions/actions as specified in one or more blocks of the flow chart and/or block diagram.

The computer-readable program instructions may also be loaded onto a computer, other programmable data processing apparatuses or other devices to execute a series of operation steps to be performed on the computer, other programmable data processing apparatuses or other devices to produce a computer implemented procedure. Therefore, the instructions executed on the computer, other programmable data processing apparatuses or other devices implement the functions/acts specified in one or more blocks of the flow chart and/or block diagram.

The flowchart and block diagrams in the drawings illustrate architecture, functions, and operations of possible implementations of systems, methods, and computer program products according to various embodiments of the present disclosure. In this regard, each block in the flowchart or block diagrams may represent a module, a part of program segment or instruction, wherein the module and the part of program segment or instruction include one or more executable instructions for performing stipulated logic functions. In some alternative implementations, the functions indicated in the block diagram can also take place in an order different from the one indicated in the figures. For example, two successive blocks may, in fact, be executed in parallel or in a reverse order dependent upon the functionality the involved. It will also be noted that each block of the block diagrams and/or flowchart and combinations of the blocks in the block diagram and/or flow chart can be implemented by a hardware-based system dedicated for executing stipulated functions or acts, or by a combination of dedicated hardware and computer instructions.

The description of various embodiments of the present disclosure have been presented for the purpose of illustration, but are not intended to be exhaustive or limited to the embodiments disclosed. Many modifications and variations will be apparent to those skilled in the art without departing from the scope and spirit of the described embodiments. The terminology used herein was chosen to best explain the principles of the embodiments, the practical application or technologies found in the marketplace, or to enable those skilled in the art to understand the embodiments disclosed herein.

1. A method for data access in a storage system, the method comprising:
receiving, from a controller among a plurality of controllers in the storage system, an access request for data, the plurality of controllers having respective local caches;
determining whether the data is located in a dedicated area of the local cache of the controller;
in response to the data being missed in the dedicated area of the local cache of the controller, determining an address of the data in a global address space, the global address space corresponding to respective shared areas in the local caches of the plurality of controllers; and
searching the data using the address in the global address space.

2. The method of claim 1, wherein searching the data using the address in the global address space comprises:
determining whether the data is located in the shared area of the local cache of the controller.

3. The method of claim 2, further comprising:
in response to the data being located in the shared area of the local cache of the controller,
accessing the data from the shared area of the local cache of the controller; and
transmitting the data to the dedicated area of the local cache of the controller.

4. The method of claim 2, further comprising:
in response to the data being missed in the shared area of the local cache of the controller,
determining, using the address, a local cache of a further controller that stores the data;
obtaining the data from the local cache of the further controller; and
transmitting the data to the dedicated area of the local cache of the controller.

5. The method of claim 1, wherein the plurality of controllers communicates with each other through internal communication interfaces.

6. An apparatus for data access in a storage system, the apparatus comprising:
an access request receiving unit configured to receive an access request for data from a controller among a plurality of controllers in the storage system, the plurality of controllers having respective local caches;
a dedicated area determining unit configured to determine whether the data is located in a dedicated area of the local cache of the controller;
a global address determining unit configured to, in response to the data being missed in the dedicated area of the local cache of the controller, determine an address of the data in a global address space, the global address space corresponding to respective shared areas in the local cache of the plurality of controllers; and
a data searching unit configured to search the data using the address in the global address space.

7. The apparatus of claim 6, wherein the data searching unit is further configured to:
determine whether the data is located in the shared area of the local cache of the controller.

8. The apparatus of claim 7, wherein the data searching unit is further configured to:
in response to the data being located in the shared area of the local cache of the controller,
access the data from the shared area of the local cache of the controller; and
transmit the data to the dedicated area of the local cache of the controller.

9. The apparatus of claim 7, wherein the data searching unit is further configured to:
in response to the data being missed in the shared area of the local cache of the controller,
determine, using the address, a local cache of a further controller that stores the data;
obtain the data from the local cache of the further controller; and
transmit the data to the dedicated area of the local cache of the controller.

10. The apparatus of claim 6, wherein the plurality of controllers communicates with each other through internal communication interfaces.

11-12. (canceled)
